(19) United States
(12) Patent Application Publication
(10) Pub. No.: US 2022/0223960 A1
(43) Pub. Date: Jul. 14, 2022

(54) Energy Storage Device for a Motor Vehicle, Motor Vehicle, and Production Method

(71) Applicant: Bayerische Motoren Werke Aktiengesellschaft, Muenchen (DE)

(72) Inventors: Philipp BOEHM, Muenchen (DE); Azad DARBANDI, Unterfoehring (DE); Felix LAASCH, Muenchen (DE); Tobias SCHMIEG, Niederstetten (DE)

(21) Appl. No.: 17/594,938

(22) PCT Filed: Mar. 5, 2020
(86) PCT No.: PCT/EP2020/055849

§ 371 Date: Nov. 3, 2021

(30) Foreign Application Priority Data
Jun. 24, 2019 (DE) 10 2019 116 969.0

(51) Int. Cl. H01M 50/213; H01M 50/244; H01M 50/249; H01M 50/517; B60K 1/04

(52) U.S. Cl. CPC H01M 50/213; H01M 50/244; B60K 2001/0438; H01M 50/517; B60K 1/04; H01M 50/249

(57) ABSTRACT

An energy storage device for a motor vehicle includes a plurality of round cells for electrochemical storage of energy and multiple retaining frames for retaining the round cells. The round cells are secured to opposing retaining frames by their ends. Cell connectors are provided on the retaining frames, which electrically contact the round cells arranged between the retaining frames from the outer sides.

### BACKGROUND AND SUMMARY OF THE INVENTION

The technology disclosed here relates to an energy storage device for a motor vehicle and to a motor vehicle having such an energy storage device. Such an energy storage device is used, for example, in battery-operated motor vehicles. For example, high-voltage stores, which have a plurality of round cells, prismatic cells or pouch cells, are known from the prior art. Round cells can be manufactured inexpensively. The integration of the round cells into the energy storage device is complex on account of the shape factor and the large number of round cells. The production of prismatic cells or pouch cells is also comparatively complex.

It is a preferred object of the technology disclosed here to reduce or to eliminate at least one disadvantage of a previously known solution or to propose an alternative solution. In particular, it is a preferred object of the technology disclosed here to provide an energy storage device that is improved with respect to at least one of the following factors: production time, production costs, complexity of the production, use of installation space, sustainability and/or component reliability. Further preferred objects can be derived from the advantageous effects of the technology disclosed here. The object(s) is/are achieved by the subject matter of the claimed invention.

The technology disclosed here relates to an energy storage device for a motor vehicle, comprising:
a plurality of round cells for electrochemical storage of energy; and
multiple retaining frames for retaining the round cells;
   wherein the round cells are secured to opposing retaining frames by their ends; and wherein cell connectors are provided on the retaining frames for the electrical connection of the round cells, which cell connectors electrically contact the round cells arranged between the retaining frames from outer sides of the retaining frames.

The electrical energy storage device is a device for storing electrical energy, in particular in order to drive at least one electric (traction) drive machine. The energy storage device comprises at least one electrochemical storage cell for storing electrical energy. For example, the energy storage device can be a high-voltage store or a high-voltage battery.

The energy storage device expediently comprises at least one storage housing. The storage housing is an enclosure, which surrounds at least the high-voltage components of the energy storage device. The storage housing is expediently of gas-tight design, such that gases that may leak out of the storage cells are collected. The housing can advantageously be used for fire protection, contact protection, intrusion protection and/or for protection against moisture and dust.

The storage housing can be produced at least partly from a metal, in particular from aluminum, an aluminum alloy, steel or a steel alloy. At least one or more of the following components can be accommodated in the at least one storage housing of the energy storage device: storage cells, components of the power electronics system, contactor(s) for interrupting the current supply to the motor vehicle, cooling elements, electrical conductors, control device(s). The components are expediently preassembled before the assembly group is assembled in the motor vehicle.

The electrical energy storage device comprises a plurality of round cells for electrochemical storage of energy. A round cell is generally accommodated in a cylindrical cell can. If the active materials of the round cell expand due to operation, the housing is tensioned in the circumferential region. Therefore, comparatively thin housing cross sections can advantageously compensate for the forces resulting from the swelling. The cell can is preferably produced from steel or a steel alloy.

The round cells can each have at least one degassing opening at each of the two ends. The degassing openings are used to allow gases arising to escape from the cell can. However, only one degassing opening per round cell can also be provided. In each case at least one degassing opening per round cell is advantageously arranged in a degassing manner toward the outer sill in the installed position. In particular, the degassing openings can be arranged and designed in such a way that gas can escape through the recesses provided in the retaining frames.

The length-to-diameter ratio of the round cells preferably has a value between 5 and 30, preferably between 7 and 15, and particularly preferably between 9 and 11. The length-to-diameter ratio is the quotient from the length of the cell can of the round cell as the numerator and the diameter of the cell can of the round cell as the denominator. In a preferred configuration, the round cells can have an (external) diameter between approximately 45 mm and 55 mm, for example. Furthermore, the round cells can advantageously have a length between 360 mm and 1100 mm, preferably between approximately 450 mm and 600 mm, and particularly preferably between approximately 520 mm and 570 mm.

According to the technology disclosed here, in their installed position, the round cells run substantially parallel (that is to say parallel, possibly with deviations that are insignificant for the function) to the vehicle transverse axis Y. The vehicle transverse axis is the axis running perpendicular to the vehicle longitudinal axis X and horizontally in the normal position of the motor vehicle.

The round cells are arranged within the storage housing in multiple layers in the direction of the vehicle vertical axis Z. In this case, the vehicle vertical axis is the axis running perpendicular to the vehicle longitudinal axis X and vertically in the normal position of the motor vehicle. A layer of round cells is in this case a plurality of round cells that are installed in the same plane in the storage housing and have substantially the same spacing from the base of the storage housing. The number of layers advantageously varies in the direction of the vehicle longitudinal axis X. According to the technology disclosed here, the storage housing can have a top side, the external housing contour of which is adapted to the lower internal contour of a passenger cabin of the motor vehicle, wherein, in the installed position, the total height of the multiple layers is varied to adapt to the housing contour in the direction of the vehicle longitudinal axis by virtue of immediately adjacent round cells of a layer in the installed position being spaced further apart from one another in a first region of the layer in the direction of the vehicle longitudinal axis than immediately adjacent round cells in a second region of the same layer, with the result that, in the first region, a further round cell of another layer advantageously penetrates further in a first intermediate region formed by the round cells immediately adjacent in the first region than an identically formed further round cell of the other layer that penetrates in a second intermediate region formed by round cells immediately adjacent in the second region. The total height of the multiple layers is calculated from the base of the storage housing to the upper end of the top layer at the respective location in the storage housing. The internal contour of the passenger cabin is the contour that delimits the interior of the passenger cabin that is accessible to a vehicle user. In particular, the housing contour can be adapted to the internal contour in such a way that an expediently uniform gap, which is preferably less than 15 cm or less than 10 cm or less than 5 cm, is provided between the top side of the storage housing and the internal contour of the passenger cabin.

According to the technology disclosed here, at least one, in the installed position of the energy storage device, bottom layer of the multiple layers can extend in the direction of the vehicle longitudinal axis from a, in the installed position, front foot region of the storage housing, the foot region being adjacent to the front footwell of the motor vehicle, up to a seat region of the storage housing, wherein the seat region is adjacent to the rear bench seat of the motor vehicle.

According to the technology disclosed here, fewer layers can be arranged in at least one of the foot regions of the storage housing that are adjacent to the front or rear footwell of the motor vehicle than in a seat region of the storage housing, wherein the seat region is adjacent to the front seats and/or the rear seats (for example individual seats or rear bench seat) of the motor vehicle. Provision can thus advantageously be made for only one bottom layer of round cells to be provided in the storage housing, for example in the front and/or rear foot region, whereas several layers can be provided in a manner stacked above one another in the front and/or rear seat region. This has the advantage that, in particular, the installation space below the front seats or below the rear seats can be utilized more efficiently in order to therefore improve the electrical storage capacity of the motor vehicle.

Provision can furthermore advantageously be made for at least the round cells of the bottom layer to be arranged in such a way that all ends of the round cells provided on one side of the bottom layer have the same polarity. The round cells of two layers arranged directly above one another are preferably oriented such that all ends of the round cells, provided on a first side, within the two layers each have the same polarity, wherein on the first side the polarity of the ends of a first layer of the two layers is opposite to the polarity of the ends of a second layer of the two layers. Such a configuration advantageously has a low internal resistance.

As an alternative, provision can be made for all electrical cell terminals of the round cells of all layers to be provided on one side. Such a configuration is particularly space-saving.

The electrical cell terminals of a round cell are particularly preferably embodied to be electrically insulated from the cell can. Therefore, the individual cell cans have a floating potential.

In a preferred configuration, provision can be made for the plurality of round cells of a layer to be connected to one another by an adhesive applied over the plurality of round cells of the same layer.

In a preferred configuration, at least one at least partly undulating position element is provided on the housing base, in which position element a plurality of round cells are accommodated in order to form a layer, in particular the bottom layer. The position element expediently runs perpendicular to the longitudinal axis of the round cells. The position element can furthermore advantageously be of strip-like design.

According to the technology disclosed here, cooling elements for cooling the round cells can be provided between at least two layers, the cooling elements preferably being of at least partly undulating design in cross section perpendicular to the vehicle longitudinal axis Y. In one configuration, the cooling elements can be connected to a cooling circuit of the motor vehicle. In one configuration, the cooling elements could be designed as a film cooler. Such a cooler would advantageously also be able to be integrated retrospectively.

The energy storage device comprises multiple retaining frames for retaining the round cells. The retaining frames can also be used to suspend/retain the cell module. Two retaining frames generally retain a plurality of round cells. The plurality of round cells is expediently arranged between the two retaining frames. This plurality of retained round cells can also be referred to as cell module. Such a cell module is expediently able to be mounted into the storage housing or into the motor vehicle as a unit. The round cells are secured to respectively opposing retaining frames by their ends. In the cell module, the individual round cells are generally oriented in each case parallel to one another. Each retaining frame particularly preferably has a length-to-height ratio of at least 3 or at least 5 or at least 10 or at least 15. The length-to-height ratio is the quotient from the length of the retaining frame (in particular the length of the retaining frame in the vehicle longitudinal direction X) as the numerator and height of the retaining frame (in particular the height of the retaining frame in the direction of the vehicle vertical axis Z) as the denominator. The retaining frame preferably extends in the installed position in the direction of the vehicle longitudinal axis over at least 15% or at least 30% or at least 50% or at least 70% of the entire length of the motor vehicle.

Cell connectors are provided on the retaining frames for the purpose of electrically interconnecting the round cells. Such cell connectors are also referred to as pole connectors or pole bridges and are part of the cell contacting system. The cell connectors are used to supply electrical energy to the individual round cells and to provide electrical energy from the round cells to the electrical consumers of the motor vehicle. The cell connectors are preferably produced from the same material as the electrical cell terminals of the round cells. The cell connectors and the electrical cell terminals are preferably produced from copper or aluminum. The cell connectors are particularly preferably welded to the electrical cell terminals of the round cells, for example by way of laser welding or ultrasonic welding, in order to electrically contact the round cells. In addition, the cell connectors could also be secured within the retaining frame by way of a form-fitting connection, for example a latching connection, insert molding or hot-caulking. The cell connectors preferably have the greatest possible cross sections in order to keep the resistance losses as low as possible. A comparatively high current flows through the cell connectors. In a preferred configuration, the cell connectors are of plate-like design, and in the installed position can expediently at least in regions be of undulating design in the longitudinal direction or in the vehicle longitudinal direction thereof in order to compensate for thermal expansions. Depending on the interconnection, such a cell connector can connect the positive poles of two round cells to two negative poles of adjacent round cells. Such a cell connector preferably has a greater cross section along the main direction of the flow of current, that is to say between the different poles (negative to positive, positive to negative) of the contacted round cells than the cross section, perpendicular thereto between the same poles (negative to negative, positive to positive). The resistance in the main direction through which current flows is thus advantageously reduced, and material and installation space can be saved in the transverse direction. Forces resulting from thermal expansion can also be reduced. This installation space can also preferably be used for the retaining frame. However, other circuit logic systems with cell connectors that are accordingly equipped differently could also be implemented. Temperature sensors, which detect the temperature of the cell connectors, are preferably provided at least at some cell connectors. Provision can advantageously be made for the cell connectors to have between two electrical cell terminals that are to be connected a region that is set back and in which, for example, electrical lines are laid, for example for the sensor system of a monitoring device (also referred to as cell voltage monitoring) for the purpose of monitoring the state of the various round cells. The cell connectors configured in this way make possible the most compact possible configuration of the energy store.

The cell connectors contact the round cells, which are arranged between retaining frames, from the outer sides of retaining frames. The outer sides are in this case the sides that form the outer side of the cell module in the assembled state.

The retaining frames preferably have recesses, in which the ends of the round cells are accommodated. The recesses particularly preferably have the same cross-sectional geometry as the round cells. The recesses are particularly preferably of circular design. The recesses particularly preferably have an internal diameter that substantially corresponds to the external diameter of the round cells. At least a portion of the recess particularly preferably runs through the entire retaining frame. In other words, a portion of the recess forms a passage opening, through which the cell connector contacts the electrical cell terminal of the accommodated round cell. The retaining frame generally comprises a plurality of recesses of identical design.

The retaining frames can particularly preferably have adhesive channels, through which, in the assembled state of the round cells, adhesive can be introduced into the recesses in order to secure the round cells. Preferably, such a large amount of adhesive has been introduced into the recesses 222 that the recesses are fluid-tight. Therefore, the round cell can advantageously be fixed within the cell module in a particularly simple and reliable manner. The cell contacting region can thus also advantageously be separated in a fluid-tight manner from the environment next to the round cells in a very simple and reliable manner. The adhesive channels are preferably accessible from an external surface of the holding frame, which expediently runs perpendicular to the longitudinal axis of the round cells accommodated in the recesses. The adhesive channels are thus particularly easily accessible for filling with adhesive. Each recess particularly preferably comprises an adhesive channel.

The ends of the round cells are particularly preferably secured in the recesses by way of a form-fitting connection and/or by way of a force-fitting connection, in particular pressing-in. In principle, any kind of form-fitting connection is conceivable, for example a latching connection, in which a part of the retaining frame engages behind a region of a round cell. Any suitable force-fitting connection is likewise conceivable, for example a press fit between the outer surfaces of the round cells and the inner surfaces of the recesses.

Each retaining frame is particularly preferably composed of multiple retaining frame elements, which each form sections of the retaining frame, wherein each retaining frame element comprises at least two recesses and preferably one cell connector. In a further preferred configuration, each retaining frame element comprises at least four recesses and preferably two cell connectors. Each retaining frame expediently comprises multiple retaining frame elements, which are each of identical design. Each of the retaining frame elements of a retaining frame is particularly preferably set up to accommodate a maximum of 24 or a maximum of 12 round cells. Therefore, small submodules can advantageously be manufactured and transported, for example via air freight. In other words, the technology disclosed here makes provision for a cell module and ultimately an energy storage device to be composed of a plurality of preassembled submodules.

Immediately adjacent retaining frame elements, that is to say retaining elements located next to one another, can be connected to one another via a form-fitting connection and in particular via a latching connection. Therefore, a modular cell module system that is composed of different retaining frame elements according to the installation space in the motor vehicle can be provided in a particularly simple and efficient manner. The retaining elements and in particular the connecting region thereof can particularly preferably be designed in such a way that adjacent retaining frame elements can be secured to one another by moving one of the retaining frame elements relative to the other retaining frame element of the adjacent retaining frame elements in the direction of the longitudinal axis of the round cells. Therefore, the following can advantageously be connected to one another at the same time by moving:
i) the adjacent retaining frame elements, and
ii) the ends of the round cells accommodated in the retaining frame element moved and the retaining frame element moved.

The retaining frame can be formed from a plurality of retaining frame elements that are secured to one another, wherein the retaining frame elements differ in terms of their contour and/or number of recesses for the purpose of better use of the installation space. For example, different retaining frame elements that can be combined to form a retaining frame in order to better match the installation space can be provided for single-layer and two-layer installation spaces.

The retaining frames or the retaining frame elements can be produced from an electrically insulating material, in particular from a plastic. Therefore, they are advantageously insulated from the surrounding regions and the round cells with respect one another. Moreover, retaining frames or retaining frame elements produced from plastic can be produced comparatively inexpensively.

According to the technology disclosed here, the cell connectors of a retaining frame can be covered from the outer side with an insulation layer, in particular an insulation film or insulation plate, for the purpose of contact protection and/or protection from moisture.

The cell connectors of a retaining frame can also preferably be cast on their outer side by way of electrically insulating casting compound for the purpose of contact protection and/or protection from moisture.

The intermediate space between the round cells and the cooling elements can preferably be filled with a thermally conductive material. The thermally conductive material is preferably a thermally conductive paste, which is used to transmit the heat of the round cells to the coolant. By way of example, a silicone with fillers can be used as thermally conductive paste in order to increase the thermal conductivity.

The top side formed by the plurality of round cells and/or the underside formed by the plurality of round cells and/or the intermediate spaces between the round cells can be provided with a flame-retardant and preferably thermally conductive medium. The flame-retardant medium expediently has a lower thermal conductivity than the thermally conductive material. The flame-retardant medium may be a polyurethane foam with fillers such as perlite, for example. In particular, the flame-retardant medium may be a thermal insulation, a heat-absorbing layer, a fire-extinguishing medium, a fire-protection coating, an intumescent medium, etc.

The flame-retardant and preferably thermally insulating medium applied to the top side formed by the plurality of round cells and/or the underside formed by the plurality of round cells is preferably additionally suitable for absorbing and distributing mechanical loads, for example resulting from crash events or from objects that penetrate from the underside of the energy storage device out.

The technology disclosed furthermore relates to a motor vehicle that the energy storage device disclosed here comprises. The motor vehicle may be a passenger vehicle, motorbike, or a commercial vehicle, for example.

The technology disclosed here can be used to produce a particularly advantageous cell module. The cell module can be produced particularly inexpensively and in a manner optimized to the installation space that is present. The retaining frame disclosed here may be able to be produced more inexpensively, in a more space-saving manner and/or more easily than conventional cell modules with tension rods. The assembly of the cell module is advantageously simplified by the technology disclosed here. For example, manufacturing steps such as crimping, tension rod welding, curing of the cooling adhesive, etc. can be omitted. The technology disclosed here can also form better protection from propagation and/or moisture exposure.

The technology disclosed here can also be described by the following aspects:
A. An energy storage device 100 for a motor vehicle 100, comprising:
   a plurality of round cells 120 for electrochemical storage of energy; and
   a storage housing 110, in which the plurality of round cells 120 are provided;
      wherein the round cells 120 in their installed position run substantially parallel to the vehicle transverse axis Y; wherein the round cells 120 are arranged in multiple layers L1, L2, L3, L4 within the storage housing 110 in the direction of the vehicle vertical axis Z; wherein the number of layers L1, L2, L3, L4 varies in the direction of the vehicle longitudinal axis X.
B. The energy storage device 100 according to aspect A, wherein a length-to-diameter ratio of the round cells 120 has a value of between 5 and 30, preferably of between 7 and 15, and particularly preferably of 9 and 11.
C. The energy storage device 100 according to aspect A or B, wherein the round cells 120 each comprise at least one coated semifinished electrode product, which does not have a mechanical separating edge perpendicular to the longitudinal axis of the round cells 120, the separating edge having been produced by a separation method step after the coating of the semifinished electrode products.
D. The energy storage device 100 according to one of the preceding aspects, wherein the round cells 120 each comprise at least one coated semifinished electrode product with a rectangular cross section, wherein the length of the longer side of the semifinished electrode product substantially corresponds to a total width of a carrier layer web, which has been coated with anode material or cathode material in order to form the semifinished electrode product.
E. The energy storage device 100 according to one of the preceding aspects, wherein the storage housing 110 has a top side, the housing contour KG of which is adapted to the lower internal contour KI of a passenger cabin 150 of the motor vehicle 100, wherein the total height HL1, HL2 of the multiple layers L1, L2, L3, L4 is varied to adapt to the housing contour KG by virtue of the immediately adjacent round cells 120, 120 of the layer L1 being spaced further apart from one another in a first region B1 of a layer L1 in the direction of the vehicle longitudinal axis X than immediately adjacent round cells 120, 120 in a second region B2 of the same layer L1.
F. The energy storage device 100 according to one of the preceding aspects, wherein at least one bottom layer L1 extends from a front foot region FV of the storage housing 110, the foot region being adjacent to the front footwell, up to a rear seat region SH of the storage housing 110, the rear seat region being adjacent to the rear seat.
G. The energy storage device 100 according to one of the preceding aspects, wherein fewer layers L1, L2, L3 are arranged in at least one of the foot regions FF, FB of the storage housing 110 that are adjacent to the front or rear foot well FV, FH than in a seat region SV, SH of the storage housing 110 that is adjacent to the front seats and/or to the rear seats.
H. The energy storage device 100 according to one of the preceding aspects, wherein at least the round cells 120 of the bottom layer L1 are oriented in such a way that all ends of the round cells 120 provided on one side of the bottom layer L1 have the same polarity.
I. The energy storage device 100 according to one of the preceding aspects, wherein a plurality of round cells 120 of a layer are connected to one another by an adhesive applied over the plurality of round cells 120.
J. The energy storage device 100 according to one of the preceding aspects, wherein at least one at least partly undulating position element is provided on the housing base, in which position element a plurality of round cells 120 are accommodated in order to form a layer L1, L2, L3.
K. The energy storage device 100 according to one of the preceding aspects, wherein cooling elements 140 for cooling the round cells 120 are provided between at least two layers, the cooling elements preferably having an at least partly undulating design.
L. The energy storage device 100 according to one of the preceding aspects, wherein the round cells 122 each have at least one degassing opening at each of the two ends.
M. A motor vehicle, comprising an energy storage device 100 according to one of the preceding aspects.
N. A method for producing an electrochemical storage cell, in particular a round cell 120, comprising the step whereby, after at least one carrier layer web forming a semifinished electrode product has been coated with cathode material or anode material, the semifinished electrode product is wound to form a storage cell, without the carrier layer web being subjected to a further separation method step in the longitudinal direction of the carrier layer web after the coating.
O. A method for producing an energy storage device 100, comprising the steps of:
   producing a plurality of storage cells in accordance with the method according to aspect N; and
   arranging the storage cells in the energy storage device 100 disclosed here.

The technology disclosed here is now explained based on the figures.

### BRIEF DESCRIPTION OF THE DRAWINGS

FIG. 1 shows a schematic perspective view of an energy store according to an exemplary embodiment of the invention.

FIG. 2 shows a schematic section of a longitudinal section through a motor vehicle according to the technology disclosed here.

FIG. 3 shows a schematic section of a longitudinal section through a motor vehicle according to a further exemplary embodiment of the technology disclosed here.

FIG. 4 shows a schematic cross-sectional view along the line IV-IV according to FIG. 5.

FIG. 5 shows a schematic cross-sectional view along the line V-V of FIG. 4.

FIG. 6 shows a schematic cross-sectional view along the line VI-VI of FIG. 4.

FIG. 7 shows a schematic cross-sectional view along the line VII-VII of FIG. 4.

FIG. 8 shows a schematic illustration of the retaining frames 200, the retaining frame elements 230, 231 and the cell connectors 220.

FIG. 9 shows an enlarged schematic illustration of retaining frame elements 230 in a further configuration.

FIG. 10 shows an enlarged schematic illustration of round cells 120 and a cell connector 220.

### DETAILED DESCRIPTION OF THE DRAWINGS

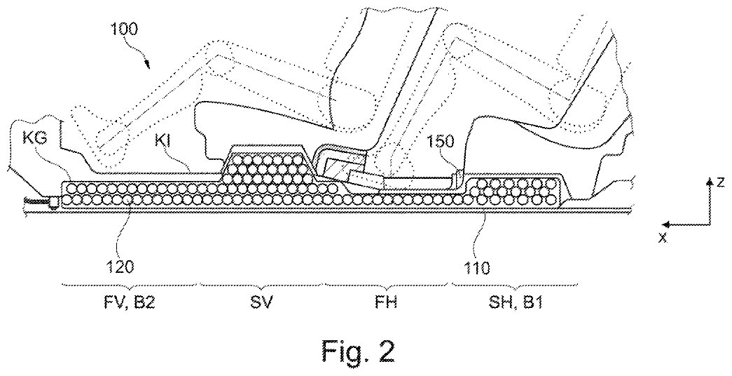

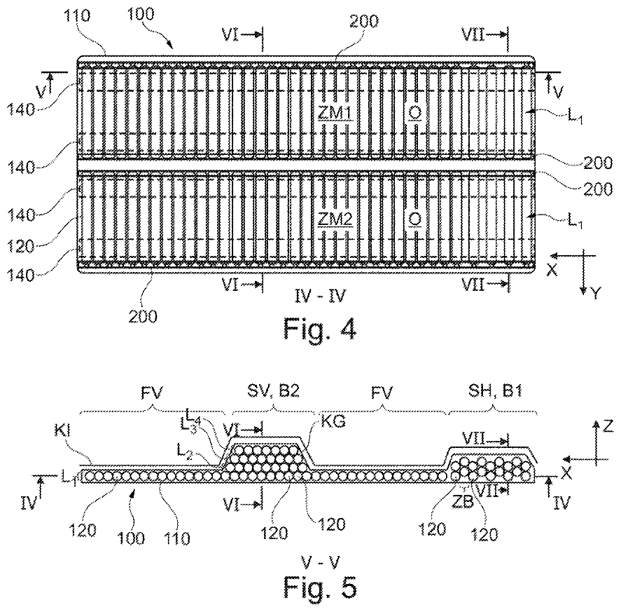

FIG. 2 shows a schematic section of a longitudinal section through a motor vehicle according to the technology disclosed here. The storage cells of the energy storage device 100 are configured here as round cells 120, which are accommodated in the storage housing 110 in a manner organized in layers. The round cells 120 are arranged here substantially parallel to the vehicle transverse axis Y. The bottom layer of round cells extends here from the front foot region FV of the storage housing 110 to the rear seat region SH of the storage housing 100 counter to the direction of the vehicle longitudinal axis X. The rear seat region SH is arranged here underneath the rear bench seat. The number of layers varies in the direction of the vehicle longitudinal axis X in order to thus utilize the installation space in optimum fashion. The height of the individual round cells 120 or the layers in the direction of the vehicle vertical axis Z results here from the maximum external diameter of the round cells 120. Since the maximum external diameter of the round cells 120 is relatively small in comparison to previously known prismatic cells, the installation space that is present in the direction of the vehicle vertical axis Z can be utilized much better here. The housing contour KG is also advantageously adapted here to the internal contour KI of the passenger cabin 150 (cf. also FIG. 5). For the purpose of better use of the installation space, the immediately adjacent round cells 120 are arranged spaced further apart from one another in the rear seat region SH or first region B1 than immediately adjacently of the round cells 120 in the front seat region SV or second region B2. By way of these measures, the round cells 120 of the immediately adjacent second layer can penetrate deeper into the intermediate regions of the first or bottom layer in the first region B1, as a result of which a total of three layers can be integrated in this first region. Without these measures, only two layers would be able to be arranged in this installation space. Two cell modules ZM1, ZM2, which each have two retaining frames 200 (cf. FIG. 4), are provided here in the energy storage device 100. The cell modules ZM1, ZM2 are arranged here parallel to one another and have the same contour in the direction of the vehicle vertical axis Z.

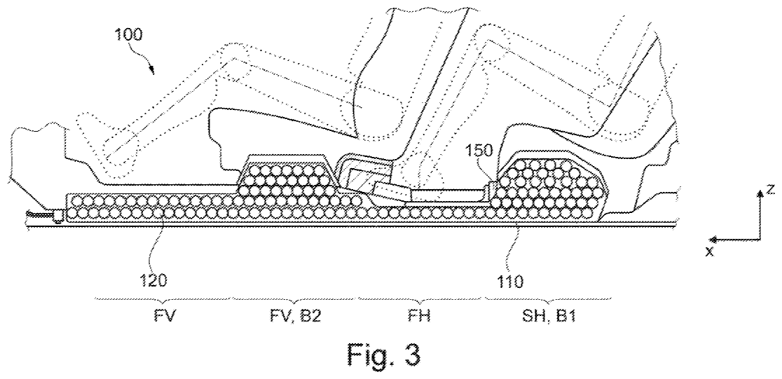

FIG. 3 shows a schematic section of a longitudinal section through a motor vehicle according to a further exemplary embodiment of the technology disclosed here. In the following description of the alternative exemplary embodiment illustrated in FIG. 3, the same reference signs are used for features that are identical and/or at least comparable in terms of their configuration and/or mode of operation in comparison to the first exemplary embodiment illustrated in FIG. 2. If these features are not explained again in detail, the configuration and/or mode of operation thereof corresponds to the configuration and/or mode of operation of the features already described above. The configuration according to FIG. 3 differs from the previous configuration in that the internal contour KI and the housing contour KG of the energy storage device 100 in the region of the rear seat bench has been changed. The energy storage device 100 here has more installation space overall in the rear seat region in the direction of the vehicle vertical axis Z. Consequently, there are further layers here in comparison to the configuration according to FIG. 2, of which the top three layers have round cells 120 that are spaced further apart in the direction of the vehicle longitudinal axis X for better adjustment to the overall height.

FIG. 5 shows a schematic cross-sectional view along the line V-V of FIG. 4. The figure shows the energy storage device 100 of FIG. 2 and the internal contour KI of the motor vehicle. The rest of the components of the motor vehicle have been omitted for simplification. FIG. 5 depicts the first intermediate region ZB, which is formed from immediately adjacent round cells 120 of the bottom layer L1.

FIG. 4 shows a schematic cross-sectional view along the line IV-IV according to FIG. 5. The plurality of round cells 120 are arranged parallel to the vehicle transverse axis Y. The round cells 120 have a length-to-diameter ratio of approximately 10. The cooling elements 140 are arranged here perpendicular to the round cells 120 and parallel to the vehicle longitudinal direction X. The cooling elements 140 are of strip-like design. The width of the cooling elements 140 is smaller than the length of the round cells 120 by a multiple. The cooling elements 140 can be of a substantially undulating design in a cross section perpendicular to the vehicle transverse axis Y. The cooling elements 140 have been omitted in the other views and cross sections for simplification. The adhesive, which can be applied here between the two cooling elements 140, is not illustrated here or in the other figures. The adhesive is expediently set up to connect the round cells 120 of a layer L1, L2, L3, L4 to one another. Likewise not shown here are the undulating position elements, which in one configuration position the bottom layer and the base of the housing relative to one another. In the configuration shown here, the electrical cell terminals of the round cells 120 are provided on the outer edge of the bottom layer L1. The round cells 120 preferably each have the degassing opening (not shown here) only at the toward the outer edge or toward the outer longitudinal support of the motor vehicle. In the embodiment illustrated here, in each case two bottom layers L1 are arranged behind one another in the direction of the vehicle transverse axis Y. The two bottom layers L1 are provided parallel to one another. It is likewise conceivable that only one bottom layer L1 or three bottom layers L1 are provided in the storage housing. It is likewise conceivable that, instead of two round cell stacks, only one round cell stack with correspondingly longer round cells 120 or three round cell stacks with correspondingly shorter round cells 120 is/are provided.

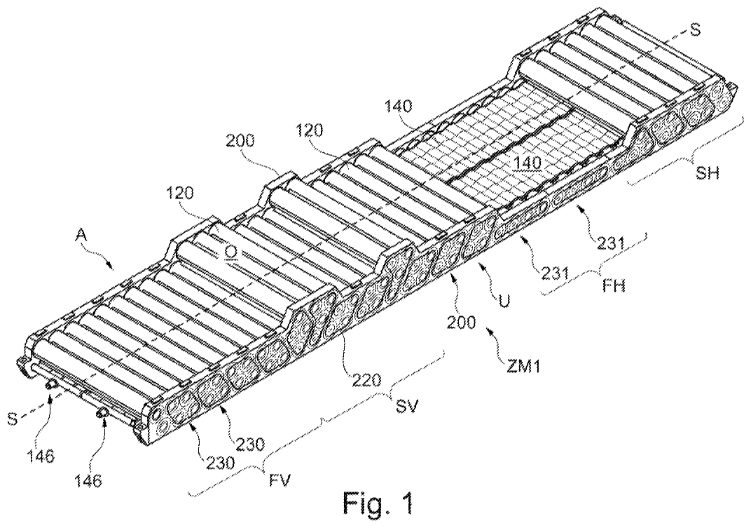

FIG. 1 shows a perspective view of a cell module ZM1 according to the technology disclosed here. The cell module ZM1 comprises a plurality of round cells 120, which are arranged parallel to one another. The plurality of round cells 120 are retained here by two retaining frames 200. The retaining frames 200 are each arranged laterally from the round cells 120. Each end of the round cells 120 is respectively accommodated in one of the two retaining frames 200. The two retaining frames 200 fix the round cells 120 here. The cell module ZM1 is likewise divided here into foot regions FV, FH and seat regions SV, SH. Here, only one layer of round cells 120 is provided in the rear foot region FH. The retaining frame elements 231, 231 installed here accordingly have a flat, single-layer contour in the direction of the vehicle vertical axis Z. Somewhat more space for the energy storage device 100 is provided here in the front foot region FV. Respective structurally identical retaining frame elements 230, which each have a two-layer construction, are accordingly installed here. The cell module ZM1 further comprises two cooling elements 140, which are arranged between the first layer L1 and the second layer L2. The terminals 146 of the cooling elements 140 are located here on the front side of the cell module ZM1.

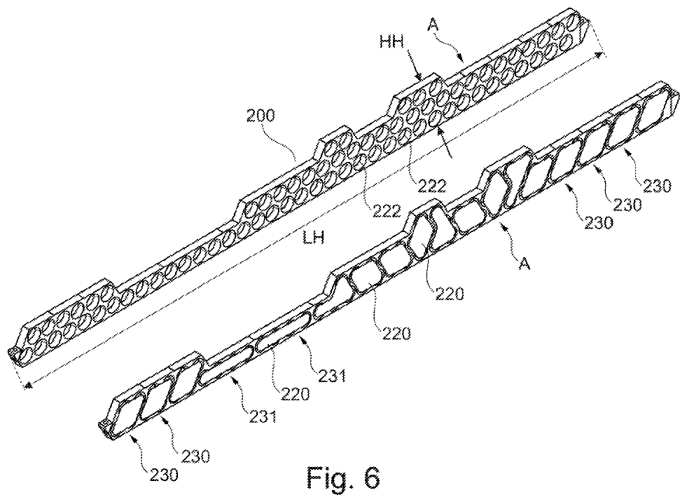

FIG. 6 shows a schematic cross-sectional view of two retaining frames 200. The contour of the retaining frame 200 corresponds to the housing contour GK of the energy storage device 100. The retaining frames 200 have a length-to-height ratio of approximately 20. In the installed position, the length LH runs here in the direction of the vehicle longitudinal axis X. The height HH here runs parallel to the vehicle vertical axis Z. Each retaining frame 200 comprises a plurality of recesses 222, in which the round cells 120 (not shown here) are inserted. The front retaining frame 200 also shows the cell connectors 220. The cell connectors 220 are configured such that they have the lowest possible electrical resistance. The shape of the cell connectors 220 is determined by the installation situation and the interconnection of the round cells 120. A preferred configuration is shown in FIG. 10. In principle, different interconnection logic systems (nP interconnection) are conceivable. The retaining frame 200 or the retaining frame elements 230 disclosed here may be (an) injection-molded part(s), for example.

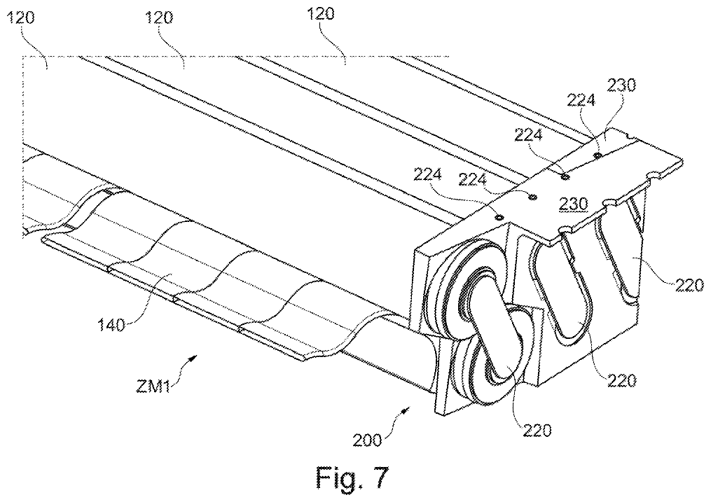

FIG. 7 shows a perspective view of a cell module ZM1 of modular construction. The retaining frame 200 here comprises a plurality of retaining frame elements 230, of which two retaining frame elements 230 are shown by way of example. Four round cells 120 are accommodated in each retaining frame element 230 here. The retaining frame element 230 is of two-layered construction. The round cells 120 are thus arranged in two layers lying one above the other. In the example shown here, the cell connector 220 connects a respective round cell 120 of the top layer to a round cell 120 of the bottom layer. The retaining frame elements 230 are connected to one another in a form-fitting manner here in each case via a clip connection (not shown). The connection region (shown using dashes) for connecting two adjacent retaining elements 230 is of stepped design here. A self-centering connection region could advantageously also be provided, for example with a V-shaped contour. The connection region is designed here in such a way that individual retaining frame elements can be secured to one another by way of sliding in the direction of the longitudinal axis of the round cells. Therefore, the following can advantageously be connected to one another at the same time by moving:
iii) the individual adjacent retaining frame elements 230, and
iv) the ends of the round cells 120 accommodated in the respective retaining frame element 230 and the respective retaining frame element 230.

A plurality of retaining frame elements 230, which are connected behind one another and connected to one another, are expanded here to form a retaining frame 200, which in the installed position extends substantially along the vehicle longitudinal axis X. By way of example, a retaining frame 200 according to FIG. 6 can comprise the retaining frame elements 230 shown here.

The manufacture of the cell module ZM1 particularly preferably makes provision for first of all the retaining elements 230 to be populated with round cells 120 to form a submodule and the cell module ZM1 is subsequently put together by connecting the individual retaining elements 230. In particular, provision can be made for the same retaining frame element 230 to be set up to be used for cell modules with retaining frames 200 of different length. Each submodule comprises corresponding terminals for the cooling elements 140 and the electrical contacts (cell monitoring system, cell connector, etc.). In another configuration, the cooling system is provided only after the submodule has been assembled. In a further configuration, the retaining frames 200 are first of all produced from individual retaining frame elements 230, 231 and the cell module is subsequently manufactured using the preassembled retaining frames 200. It is expediently possible to preassemble one of the retaining frames 200, in which the round cells 200 (with or without an intermediate layer of the cooling element(s) 140) are first of all inserted before the opposing second retaining frame 200 is subsequently successively manufactured by way of secured individual retaining frame elements 230. This method is also applicable to differently configured energy storage devices and other exemplary embodiments. Therefore, advantageously only the few round cells 120 that are accommodated in the retaining frame element 230 that is to be secured have to be positioned exactly. This can simplify the assembly.

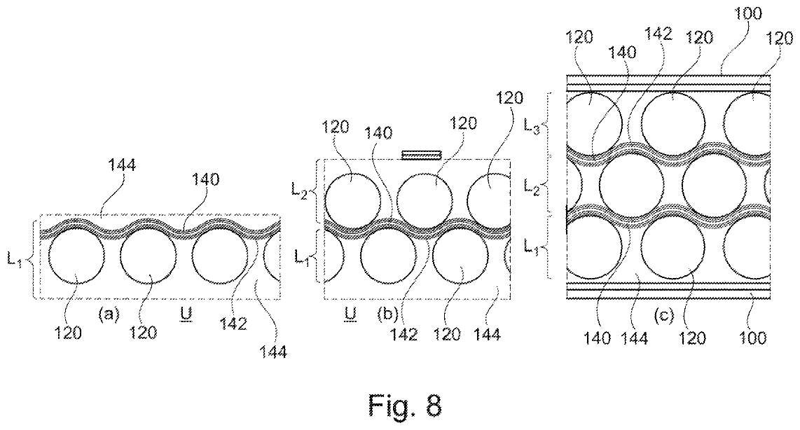

FIG. 8 shows a schematic cross-sectional view at various points of the cell module ZM1.

The left-hand part (a) of FIG. 8 shows a section as may be provided, for example, in the rear foot region FH of FIG. 1. The, in this case undulating, cooling element 140 is provided here at the top. The round cells 120 contact the undulating cooling element 140 on the bottom side thereof. The round cells 120 can therefore output the heat to the cooling element 140 well. The thermally conductive material 142 can also be arranged here between the round cells 120 and the cooling element 140. The heat can therefore be transmitted particularly well to the cooling element 140. The thermally conductive material 142 may be, for example, a silicone with fillers for increasing the thermal conductivity. A flame-retardant medium 144, for example an anti-propagation paste (for example thermal insulation, heat-absorbing layer, or a fire-extinguishing medium) could be provided as further protection for the bottom side U. The flame-retardant medium 144 is provided equally on the top side of the cooling element 140 and between the round cells.

The central part (b) of FIG. 8 shows a section as may be provided, for example, in the front foot region FV of FIG. 1. Two layers L1, L2 of round cells 120 are provided here, the layers being arranged above one another in the direction of the vehicle vertical axis Z. The cooling element 140 is arranged here in the intermediate layer between the two layers L1, L2. In a similar manner to in part (a), a thermally conductive material 142 is provided here toward the cooling element 140. The flame-retardant medium 144 is again provided here towards the top side 0 and towards the bottom side U as well as between the round cells.

The right-hand part (c) of FIG. 8 shows a section as can be provided, for example, in the front seat region SV of FIG. 1. Three layers L1, L2, L3 are arranged in this region one above the other. A respective cooling element 140 is arranged between two layers. For further protection from propagation, provision may be made for the flame-retardant medium 144 to also be inserted within the layer construction. A part of the housing 100 is additionally shown in this cross-sectional view.

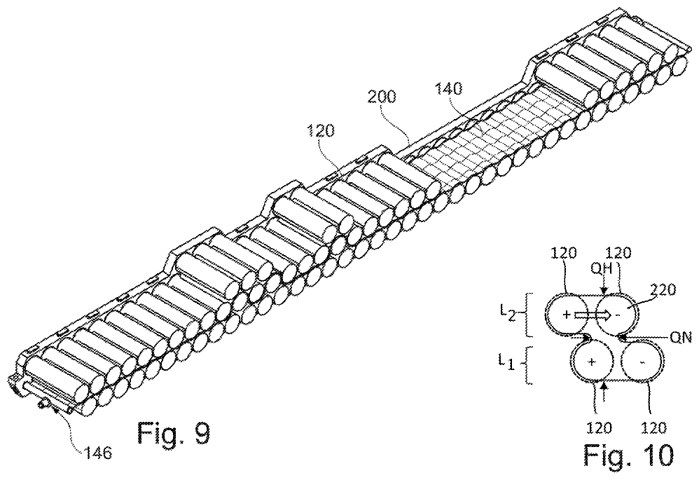

FIG. 9 shows a schematic cross-sectional view of the cell module ZM1 along the sectional line S-S of FIG. 1. The undulating cooling element 140 is configured here in the front seat region SV in such a way that the cooling element 140 does not run exclusively here between the first layer 1 and the second layer L2. The cooling element 140 runs in the three layers L1, L2, L3 arranged one above the other along the longitudinal direction of the layers or vehicle longitudinal direction X alternately between the first layer L1 and the second L2 and the second layer L2 and the third layer L3. In this region, the cooling element 140 loops around adjacent round cells 120 of the second layer L2 in the longitudinal direction. It is therefore particularly simple to cool the three layers L 1, L2, L3 using a cooling element 140. Multiple cooling elements 140 can preferably be arranged next to one another in the transverse direction (that is to say in the longitudinal direction of the round cells 120).

FIG. 10 shows an enlarged schematic illustration of round cells 120 and a cell connector 220. Such a cell connector can be installed in each of the energy storage devices disclosed here. However, other geometries may also be conceivable. Along the main direction (illustrated as an arrow) of the flow of current—that is to say between the different poles (negative to positive, positive to negative) of the contacted round cells 120 (or here in the direction of the longitudinal axis of the retaining frames or of the vehicle longitudinal axis), the cell connector 220 has a greater cross section QH than perpendicular to this cross section QN—that is to say between the same poles (negative to negative, positive to positive) or in the direction of the vehicle vertical axis Z.

The cross-sectional ratio of the cross-sectional area in the main direction to the cross-sectional area perpendicular thereto preferably has a value of at least 2 or at least 5 or at least 10. The cross-sectional ratio is the quotient from the cross-sectional area in the main direction as the numerator and the cross-sectional area perpendicular to the cross-sectional area in the main direction as the denominator.

The resistance in the main direction through which current flows is thus advantageously reduced, and material and installation space can be saved in the transverse direction. Forces resulting from thermal expansion can also be reduced. This installation space can preferably be used for the retaining frame.

The preceding description of the present invention is used only for illustrative purposes and not for the purpose of restricting the invention. Within the scope of the invention, various changes and modifications are possible without departing from the scope of the invention and the equivalents thereof. Even if the energy storage device is shown here with round cells, the technology disclosed here can equally be applied to other cell geometries that expediently have the cross section-to-length ratios disclosed here.

1.-15. (canceled)

16. An energy storage device for a motor vehicle, the energy storage device comprising:
a plurality of round cells for electrochemical storage of energy; and
a plurality of retaining frames for retaining the round cells; wherein:
the round cells are secured to opposing retaining frames by ends of the round cells;
cell connectors are provided on the retaining frames; and
the cell connectors electrically contact the round cells arranged between the retaining frames from outer sides of the retaining frames.

17. The energy storage device according to claim 16, wherein the retaining frames comprise recesses in which the ends of the round cells are accommodated.

18. The energy storage device according to claim 17, wherein the retaining frames further comprise adhesive channels through which, in an assembled state of the round cells, adhesive is introducible introduced into the recesses in order to secure the round cells.

19. The energy storage device according to claim 17, wherein the ends of the round cells are secured in the recesses by way of at least one of a form-fitting connection or a force-fitting connection.

20. The energy storage device according to claim 19, wherein the form-fitting connection is pressing-in.

21. The energy storage device according to claim 16, wherein:
each retaining frame is composed of multiple retaining frame elements, and
each retaining frame element comprises at least two recesses.

22. The energy storage device according to claim 21, wherein immediately adjacent retaining frame elements are connected to one another via a form-fitting connection.

23. The energy storage device according to claim 22, wherein the form-fitting connection is a latching connection.

24. The energy storage device according to claim 21, wherein:
the retaining frame is formed from a plurality of retaining frame elements that are secured to one another; and
the retaining frame elements differ in terms of at least one of a contour or a number of recesses to better use an installation space.

25. The energy storage device according to claim 21, wherein at least one of the retaining frames or the retaining frame elements are produced from an electrically insulating material.

26. The energy storage device according to claim 16, wherein at least one of:
the cell connectors of a retaining frame are covered from an outer side with an insulation layer; or
the cell connectors of the retaining frame are cast on the outer side by way of electrically insulating casting compound.

27. The energy storage device according to claim 26, wherein
the insulation layer is an insulation film or an insulation plate.

28. The energy storage device according to claim 16, wherein:
the round cells are arranged in layers;
cooling elements for cooling the round cells are provided between at least two of the layers; and
the cooling elements are of at least partly undulating design.

29. The energy storage device according to claim 28, wherein at least one of:
an intermediate space between the round cells and the cooling elements is filled at least partly with a thermally conductive material; or
at least one of a top side formed by the plurality of round cells, a bottom side formed by the plurality of round cells, or intermediate spaces between the round cells are provided with a flame-retardant medium.

30. The energy storage device according to claim 16, wherein:
the round cells in their installed position run substantially parallel to a vehicle transverse axis;
the round cells are arranged in multiple layers within a storage housing in a direction of a vehicle vertical axis; and
a number of the layers varies in a direction of a vehicle longitudinal axis.

31. The energy storage device according to claim 16, wherein a length-to-diameter ratio of the round cells has a value between 5 and 30.

32. The energy storage device according to claim 31, wherein the value is between 7 and 15.

33. The energy storage device according to claim 32, wherein the value is between 9 and 11.

34. The energy storage device according to claim 30, wherein fewer layers are arranged in at least one of foot regions of the storage housing, the foot regions adjoining a front or rear footwell, than in a seat region of the storage housing, the seat region adjoining at least one of the front seats or the rear seats.

35. A motor vehicle comprising the energy storage device according to claim 16.
